(19) United States
(12) Patent Application Publication
(10) Pub. No.: US 2002/0019851 A1
(43) Pub. Date: Feb. 14, 2002

(54) System and method for the electronic mail based management and manipulation of stored files

(76) Inventor: Jordan Pollack, Sudbury, MA (US)

Correspondence Address: IANDIORIO & TESKA, INTELLECTUAL PROPERTY LAW ATTORNEYS, 260 BEAR HILL ROAD, WALTHAM, MA, 02451-1018, US

(21) Appl. No.: 09/915,425

(22) Filed: Jul. 26, 2001

Related U.S. Application Data
(60) Provisional application No. 60/220,886, filed on Jul. 26, 2000.

(51) Int. Cl. G06F 17/30; G06F 15/16; G06F 7/00

(52) U.S. Cl. 709/206; 707/10

(57) ABSTRACT

A system for management and manipulation of stored files through electronic mail items including a receiving portal for receiving from a sender an electronic mail item which contains a user identification, a file handle and a command specification, a storage device containing a file corresponding to the file handle, a rights verifier for determining whether or not the sender has privilege to access the stored file corresponding to the file handle, and a command executor which executes the command specification on the file retrieved from the storage device when the sender is verified to have the access rights to the file.

### RELATED APPLICATIONS

This application claims priority of U.S. Provisional Patent Application Serail No. 60/220,886 filed Jul. 26, 2000 entitled “Electronic Mail Based Management and Manipulation of Stored Files.” This application is also related to U.S. patent application Ser. No. 09/302,877 filed Apr. 30, 1999 entitled “Network-Based Mail Attachment Storage System and Method” which is incorporated herein in its entirety.

### FIELD OF INVENTION

This invention relates to a network based storage system for computer files, and is specifically related to a system and method which detaches and stores email attachments and replaces them with a handle to enable the recipient to retrieve the stored attachments at a later time. It enables the useful ability to perform remote control functions on the stored attachments without first downloading them to a computer.

### BACKGROUND OF INVENTION

Electronic mail has evolved such that many messages contain attachments which require office applications to interpret the attachments, and which also require storage, graphics, sound, and video. Email is also moving into new wireless configurations using devices such as palm sized computers, pagers and cellular telephones which lack screen space, bandwidth, sound, video, and especially office applications which can interpret complex file formats. These wireless appliances seem very useful, but because they do not enable the processing of attachments, they fail to be useful in business communications.

U.S. patent application Ser. No. 09/302,877, filed Apr. 30, 1999 by the inventor of the subject application is a general purpose and universal email-based file transfer and file management system and method which forwards email while stripping and storing attachments on a server. A user sends email with attachments the system of the '877 application with a specification of the desired recipient, and the system then strips the attachment, stores it on a network storage device, and replaces the attachment with a handle to the file on the storage device. Instead of receiving an attachment forced onto their own server or client, the recipient receives a short text handle which looks like a URL, and allows the file to be downloaded later using a conventional internet browser. Unlike conventional web-drives in which files must be uploaded manually from a desktop, mailed to the server, or uploaded through a web browser, the '877 system and method creates a dynamic web drive with files which have been sent and received via email for the user. Simply “clicking” on a URL is often enough to trigger a download of a file.

However, there are many devices which are not powerful enough to run an internet browser, or are connected to the internet by channels so narrow that they cannot download the data from attachments.

Some available products allow for indirect manipulation of attachments which are stored on a server, so while a user cannot access an attachment, preview text, convert or delete, they can forward the message to a third party or a fax machine. This indirect manipulation only partially solves the problem of email attachments for mobile devices, and are very device dependent, managed through hidden serial numbers which are manipulated by firmware in specific devices.

### SUMMARY OF INVENTION

It is therefore an object of this invention to provide such a system and method for electronic—mail based manipulation and management of stored files, to allow a user to quickly and easily manage the files on a network storage system from any device.

It is a further object of this invention to provide such a system which balances security with ease of use, so that if user presents a command, along with a file handle from a recognized device or email address, they may be entitled to command and control their file.

It is a further object of this invention to provide such a system which allows the user to perform a myriad of functions on their files through simple email commands without actually downloading the file. Without limitation, these include retrieving the file, forwarding the file, faxing the file, and running computer programs, such as format conversion, speech recognition, and language translation on the files. It also includes management of the files as traditionally provided by an operating system, for example, deleting, moving, renaming files. In the case of a network storage system with autodeletion timers, management would allow the user to change the autodeletion date of a file as well.

This invention results from the realization that a truly effective system and method for electronic mail based management and manipulation of stored files can be achieved by accepting a message containing a file handle, a command specification, and a sender identification, validating that the sender has the rights to the file corresponding to the file handle, and only then triggering the command executor on the file retrieved from the storage system. The file handle may look like a URL, but is a private key to the file, received privated in communications. From a browser, accessing the key would require a logon and a password, or verification of a security method like a “cookie”, but via messaging, its obscurity together with the sender's identification, provides enough security. The command may be in the email address itself, in the Subject of the email, in the body, or assembled from multiple locations in the message. Finally, the sender identification may be derived from the “from” address of the email as well as other information carried in the header or body of the message.

A system for management and manipulation of stored files through electronic mail items including a receiving portal for receiving from a sender an electronic mail item which contains a user identification, a file handle and a command specification, a storage device containing a file corresponding to the file handle, a rights verifier for determining whether or not the sender has privilege to access the stored file corresponding to the file handle, and a command executor which executes said command specification on the file retrieved from the storage device when the sender is verified to have the access rights to the file.

The system for management and manipulation stored of stored files may include a file handle recognizer for locating conforming file handle patterns within the body of the electronic mail item, a user identification system which extracts information from the electronic mail item including the from address, destination address, the subject, the reply-to, and the body of the electronic mail item, to enable verification of the sender as a known user of the system, and/or a command parser which recognizes and assembles a command out of the information extracted from the electronic mail.

The command specification may instruct the command executor to delete the file from the storage device, to retrieve the file as an email attachment, to forward the file to a third party as an email attachment, to forward to a third party a newly constructed file handle to the file stored on the storage device, to print the file on a fax machine at a specified telephone number, to convert the file to plain text and email it back to the sender, to convert the file to an audio file and to forward the audio file to a telephone at a specified number, to automatically print the file and mail it to a third party, or to change the date of autodeletion of the file.

The system may include at least one of an optical character recognition device, automatic speech recognition device, language translation device, and a file format translation device associated with the command executor. The storage device may include an automatic deletion timer associated with at least one of the stored files. The file handle may be a uniform resource locator. The storage device may be chosen from the group consisting of hard drives, optical drives, random access memories, tape drives, RAID arrays, and storage area networks.

This invention also features a method for the electronic mail based management and manipulation of stored files including the steps of receiving from a sender an electronic mail item which contains an user identification, a file handle and a command specification, determining whether or not the sender has privilege to access the stored file corresponding to the file handle, retrieving the file from a storage device corresponding to the file handle, and executing the command specification on the file retrieved from the storage device when the sender is determined to have access rights to the file.

This invention also features a computer readable medium having a plurality of instructions stored thereon which, when executed by a processor, cause the processor to perform the steps of receiving from a sender an electronic mail item which contains an user identification, a file handle and a command specification, determining whether or not the sender has privilege to access a file stored on a storage device corresponding to the file handle, retrieving the stored file from the storage device, and executing the command specification on the retrieved file when the sender is determined to have the access rights to said file.

The computer readable medium may be a hard drive, optical drive, Random Access Memory, Read Only Memory, or tape drive.

This invention also features a processor and memory configured to perform the steps of, receiving from a sender an electronic mail item which contains an user identification, a file handle, and a command specification, determining whether or not the sender has privilege to access a file stored on a storage device corresponding to the file handle, retrieving the stored file from the storage device, and executing the command specification on the retrieved file when the sender is determined to have the access rights to the file.

The processor and memory may be incorporated into a personal computer, a programmable logic controller, a single board computer, or an array of network servers.

The system for the electronic mail based management and manipulation of stored files may be implemented on a mainframe computer, a minicomputer, server device, a personal computer, a microcomputer, a handheld computer or a cluster of computers. The storage for files may be chosen from a group consisting of hard drives, optical drives, random access memories, tape drives, RAID arrays, Storage Area Networks, or network attached storage. The Rights verifier may be implemented as an expert system, a graph, a table, a spreadsheet, a list or tree, or as part of a relational database, the preferred embodiment for scaling information.

The command executor may involve different subroutines and resources for each potential or actual command and may involve triggering changes in the network storage system itself, dispatching a program to run on a file, queing a file to a perpetually running process, farming work to a network of computers running programs, outsourcing the file across the internet or telephone network via a third party provider.

### BRIEF DESCRIPTION OF THE DRAWINGS

Other objects, features, and advantages will occur to those skilled in the art from the following description of a preferred embodiment and the accompanying drawings, in which:

FIG. 1 is a diagrammatic view of an embodiment of the system for electronic mail based management and manipulation of stored files according to the present invention;

FIG. 2 is a diagrammatic view of the rights verifier of the system shown in FIG. 1;

FIG. 3 is a diagrammatic view of the command executor of the system shown in FIG. 1;

FIG. 4 is a diagrammatic view of an electronic mail item used in the present invention;

FIG. 5 is a diagrammatic view of an electronic mail item including additional security components for use with the present invention;

FIG. 6 is a diagrammatic view of an electronic mail item for use with the present invention to effect forwarding of a file;

FIG. 7 is a diagrammatic view of an alternate electronic mail item for use with the present invention to effect forwarding of a file;

FIG. 8 is a diagrammatic view of another electronic mail item for use with the present invention;

FIG. 9 is a diagrammatic view of the system of the present invention incorporated into a portable device;

FIG. 10 is a diagram of the method for electronic mail based management and manipulation of stored files according to the present invention;

FIG. 11 is a diagram of the method for electronic mail based management and manipulation of stored files according to the present invention embodied in a processor and memory; and

FIG. 12 is a diagram of the method for electronic mail based management and manipulation of stored files according to the present invention embodied in a computer readable medium.

### DISCLOSURE OF THE PREFERRED EMBODIMENT

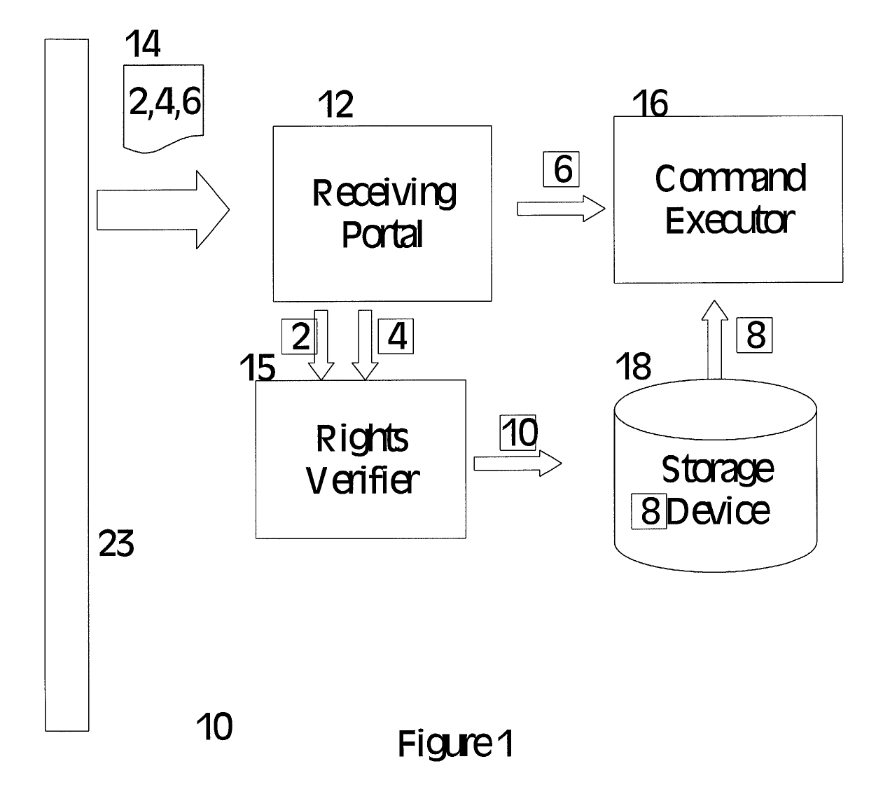

In accordance with this invention, the system for electronic mail based management and manipulation of stored files, 10, FIG. 1 includes a receiving portal 12 for receiving an electronic mail item 14 from a sender. The electronic mail item (email) 14 contains several pieces of information, including user identification 2, file handle 4, and command specification (command) 6. Electronic mail item 14 is transmitted via some form of computer network 23, such as the Internet or a corporate intranet. Receiving portal 12 can be a software program listening to a particular port of network 23, or a program which runs every time an email is received within a range of email addresses.

Receiving portal 12 locates within the electronic mail item 14 three components to trigger management or manipulation of a stored file 8; user identification 2, file handle 4, and command specification 6. User identification 2 and file handle 4 are submitted to rights verifier 15, which compares the sender with a known list of users, and accesses a table or database which specifies the file handles those users are privileged to access. If rights verifier 15 determines that the user shall have access to the file 8, rights verifier 15 triggers the release of the file corresponding to file handle 4 from storage device 18 to command executor 16. The storage device 18 can be any typical storage device, such as a hard drive, optical drive, or raid array.

Receiving portal 12 identifies the user's command specification 6, and sends the command specification to command executor 16. When command executor 16 receives both the command specification 6 and the released file 8, the command executor executes the user's desired management or manipulation of the stored file.

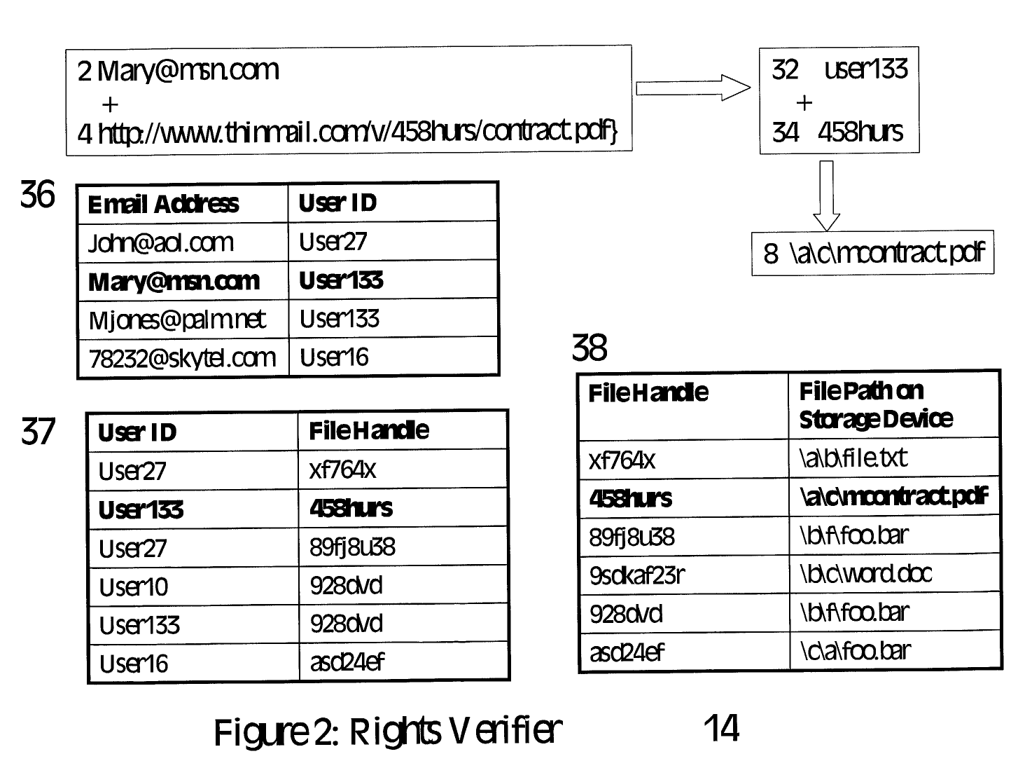

FIG. 2 shows one embodiment of a rights verifier 15 using a relational database to associate the users' multiple email addresses to specific user ids 36, the user ids to random file handles, 37, and the file handles to specific file paths 38 on storage device 18. Rights verifier 15 can also be implemented as an expert system, and could involve more than the sender's email address, such as codes and keys embedded in the electronic mail item 14, or information about the sender preserved by the path the electronic mail item 14 took to arrive at the receiving portal 12. The user identification 2 is looked up in a table of users 36 to find the specific user ID 32 associated with the user identification 2. Key 34 is extracted from file handle 4 and looked up in a table, 37, to see if the user id has rights to the file 18. If so, the file handle to file table 38 is queried to locate the actual file on storage device 18. There are many other embodiments of security which can be used to verify that a user has rights, such as use-once codes. Extracting the file handle from the URL may be as simple as removing a substring from a URL as shown, but can also be embodied as a securely encrypted string which must be decoded to find the file on storage device 18.

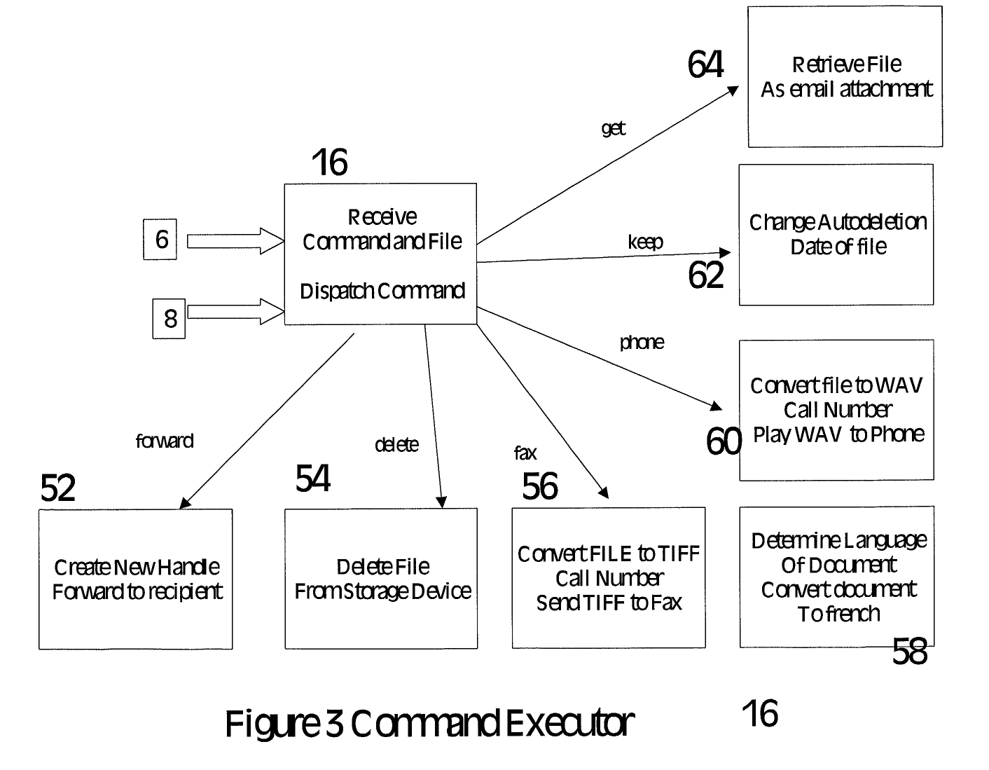

FIG. 3 shows command executor 16 which accepts the command specification 6 or the command and parameters and the file 8 from the storage device 18. Command executor 16 may include application programs such as file format conversions, 56 and 60, access to the storage devices 62 and 54, and connection to email 64 and 52, fax 56, and phone 60 portals enabling the desired remote control management and manipulation of the file 8.

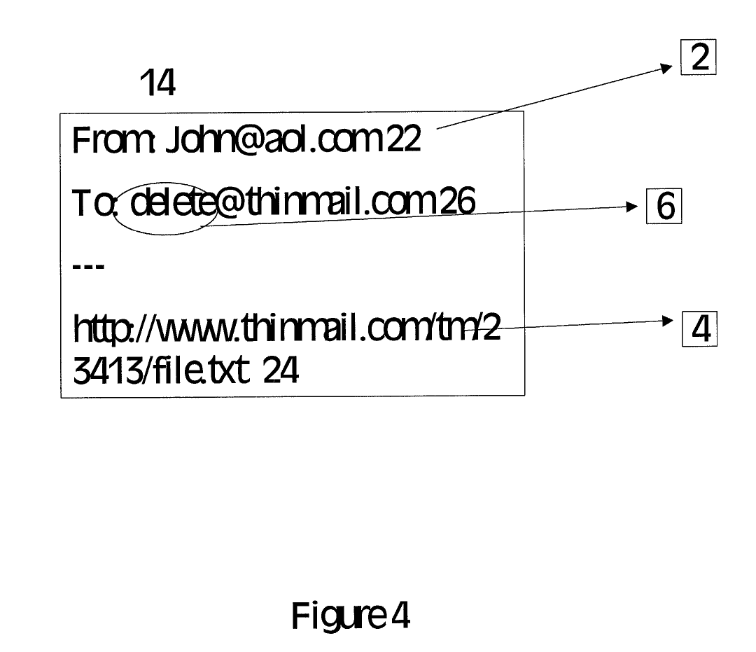

FIG. 4 shows electronic mail item 14 and its components; user identification, 2 file handle 4, and command specification 6. In this embodiment, the user identification 2 is directly in the FROM address 22 of electronic mail item 14, and the command specification 6 is part of the destination email address 26 at the domain address of the system. Alternative embodiments could have the command specification be part of the first line of electronic mail item 14, or all or part of the subject line of the electronic mail item 14. File handle 4 is parsed by recognizing a particular string 24 in the body of the message. It is not a general URL to anywhere on the Internet, but a particular key to a file known only to the user. In the email depicted in FIG. 4, the user wishes to delete a file from the storage device 18. Besides deletion, the user could request the file be converted to text and be sent back (Text@thinmail.com). Another command, GET@THINMAIL.COM can be used to retrieve entire files, converting the file handle into an actual attachment. The usefulness of the get command is not specific to a wireless device, but to a desktop which can store and process the attachment. It will be clear that arbitrary other remote control commands are enabled by this innovative system.

Many alternative commands can be easily managed using the same electronic mail based management and manipulation of stored files, with the ability to add parameters to the command. The file can be faxed, the file can be renamed, the file can be printed and bound, the file can be forwarded to a third party, or the file can be translated into a different format or different language (e.g. French@thinmail.com 58). This invention embodies the means by which stored files can be manipulated and managed using electronic mail messages without limitation to the forms of manipulation or management.

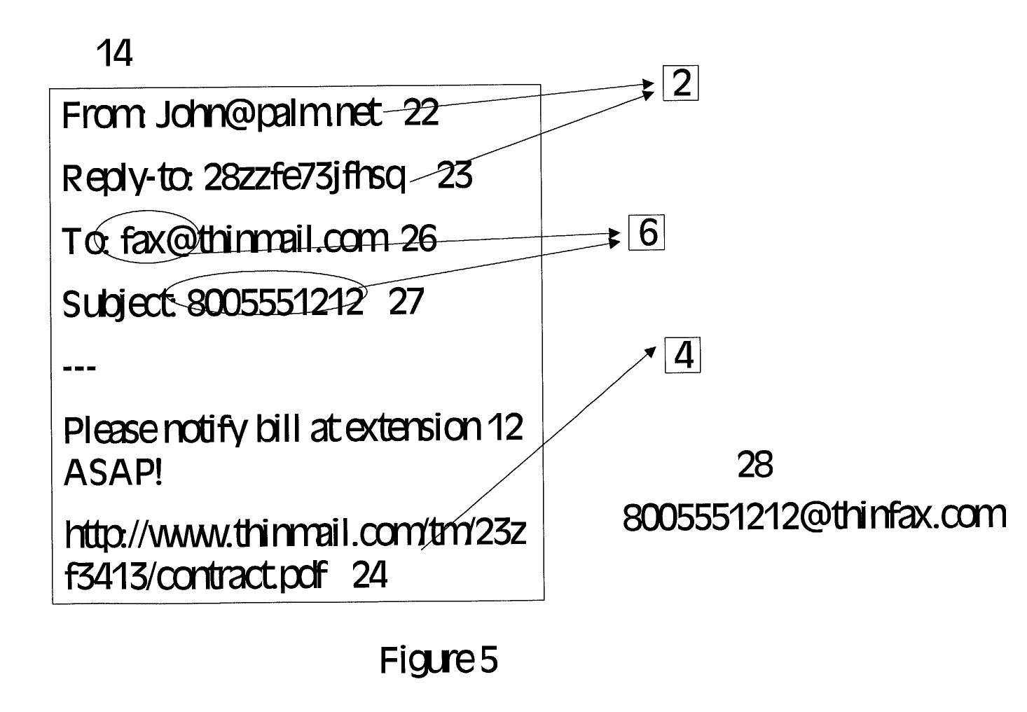

FIG. 5 shows how the electronic mail item 14 contains a more secure user identification 2, including a temporary key 23 traveling as the “reply-to” field of the electronic mail item 14. User identification 2 would require both a recognized FROM address 22, and key 23 which could be changed periodically or continuously to guard against the loss of data or portable devices. Key 23 could be encoded into the FROM or TO address, placed in another header, hidden in the boundary of a MIME message, encoded into the subject, or body of email 14. FIG. 5 also shows that email 14 can contain command specification 6 with arbitrary parameters. In this embodiment, command specification 6 instructs the command executor 16 to fax the file. The command specification 6 encoded as the destination address 26 of email 14 at the domain address of the system. A fax command requires a phone number locating the desired output fax machine, which in this case is represented in the subject line 27 of email 14. Alternatives, such as encoding the phone number and the command into a single address, such as 8005551212@thinfax.com 28 can be used, as well as placing the command in the body or other headers of the email.

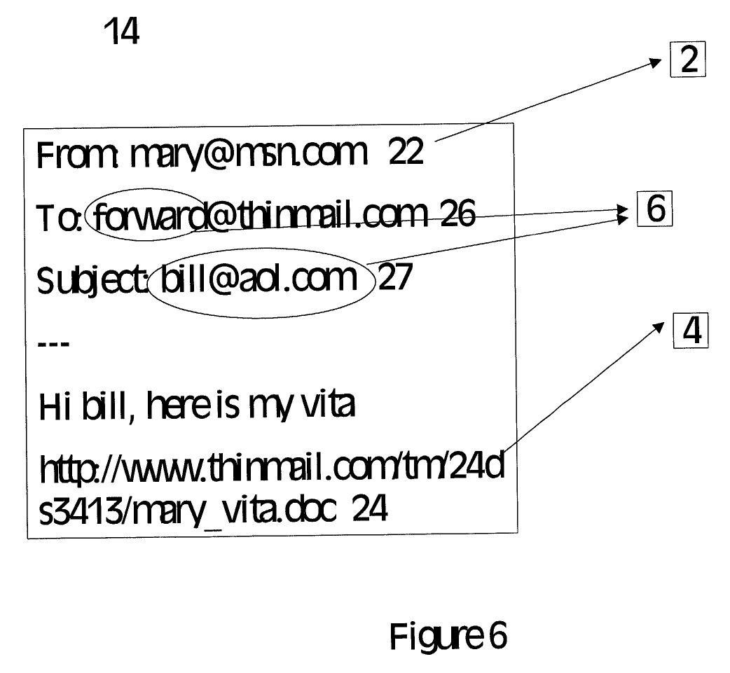

FIG. 6 depicts an electronic mail item for use with the system for remote control manipulation and management of stored files to forward a file from email without having the file inside the email device. Command specification 6 is interpreted to forward the file specified by file handle 24 to the new recipient 27, which is the parameter to the forward command encoded in the subject. Just as the fax command and fax number can be combined into a single email address encoded in the TO header, the forward command and recipient address can be combined.

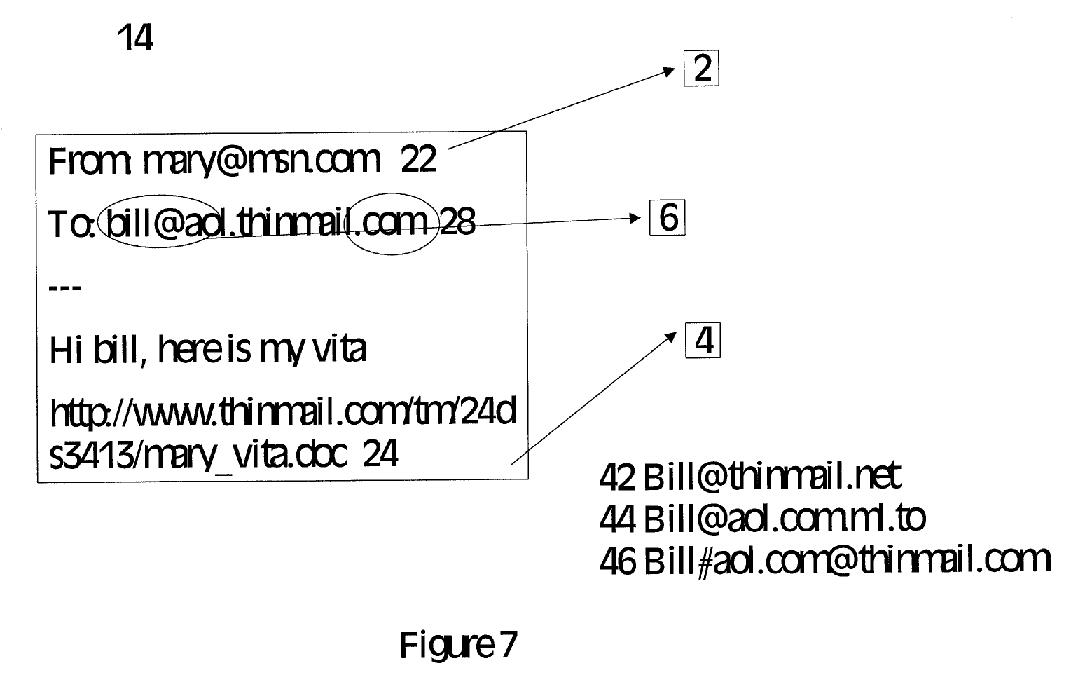

FIG. 7 demonstrates that the FORWARD command can be made implicit where the system recognizes that a recipient address combined with a file handle is a command to forward the email. In FIG. 7, the implicit command (forward) and parameter (bill@aol.com) are embedded in the email recipient 28, bill@aol.Thinmail.com, which arrives at receiving portal 12 because of the domain “Thinmail.com.” Receiving portal 12 treats this as a forward command with the parameter. Many embodiments of recipient representation are possible. For example, Bill@thinmail.net might forward to aol.com, bill@aol.com.ml.to uses the domain “ml.to” as an appendage to an email address, and Bill#aol.com@thinmail.com represents the “@” as a the “#” at the receiving portal domain. Practitioners skilled in the art of regular expression matching will appreciate that this forwarding specification has an unlimited number of alternative embodiments.

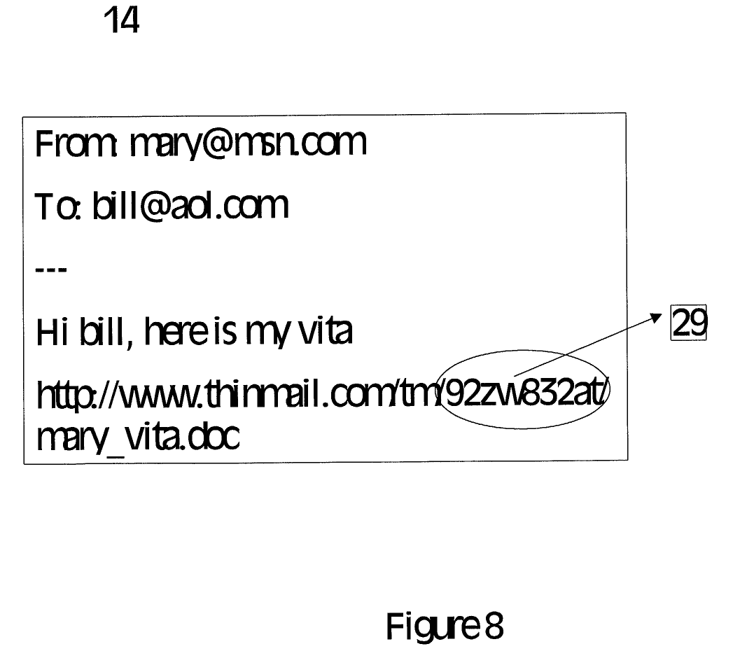

FIG. 8 depicts the resultant output of command executor 16 for electronic mail items as shown in FIGS. 6 and 7. The system 10 emits an email message to the desired recipient of the email, with a new file handle in place of the original file handle. The effect of this “forward” technique would be for the command executor 16 to modify rights verifier 15 by creating a new user, and giving this user the rights to the same file, under a different file handle, that the sender had rights to. This function to be able to remotely forward a file as a private file handle enables a powerful network for electronic mail, in which access rights to files can be sent to and fro on a broader scale, without the actual movement of files. This enables more powerful electronic mail functions on compact and limited devices.

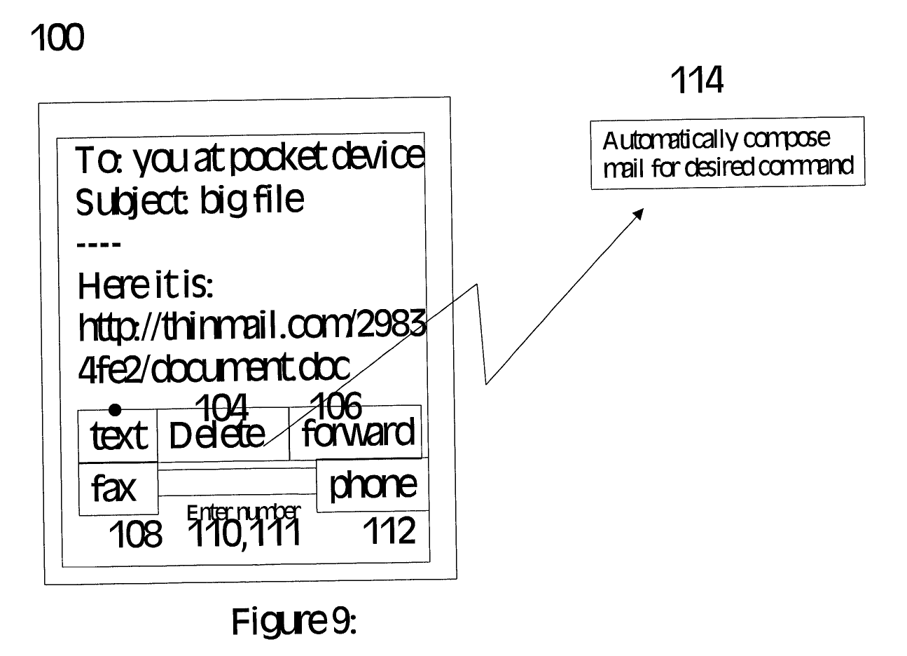

FIG. 9 shows a compact email device 100, upon which messages are received with private file handles instead of file attachments. Soft buttons, which are programmable touchable regions of a screen, can be set up for easy to use functions for managing and manipulating the contents of the electronic mail on the storage server. The system and method of the present invention would enable remote control of email attachments on such a device.

Although not all possible commands have been shown, once the described system for email based management and manipulation of stored files with a receiving portal, a rights verifier, a storage device, and a command executor is established, a whole plethora of software applications and functions may be invoked by remote control on the stored files.

A dramatic increase in usefulness is provided by a simple command, LIST, which can take a wildcard command specification as its parameter and query the rights verifier for a list of file handles valid for the user. Returning the handles in an email message enables the user to invoke commands on the files which are no longer associated with a particular email message. Following FIGS. 4-8, the text below illustrates the behavior:

To: list@thinmail.com

From: jbpollack@palm.net

Subject: *.pdf

The server would find all the PDF files for this user and return them in an email.

To: jbpollack@palm.net

From: Daemon@thinmail.com

Subject: Directory listing

http://thinmail.com/v/83f893/whitepaper.pdf

http://thinmail.com/v/83cj38/presentation.pdf

http ://thinmail.com/v/7fch38d/how-to.pdf

Given the list of files, the user can write down the URL inside a web browser or inside another message, or use “cut and paste” to select a specific file into another command.

On machines which do not allow “cut and paste” of forwarded messages, the user can forward a message with multiple file handles to the SPLIT command which takes a list, verifies each one, and sends each one back as an individual message.

The valuable delete command allows users to manage the storage and file set. See FIG. 4. Sending file handles to delete@thinmail.com leads to deletion of files from the system. The keep@Thinmail.com command can be used to change the expiration date on files.

Oftentimes, one will receive an unwanted attachment with a product advertisement, and never wish to hear from the sender again. A command can be used wherein the user can forward the file handle to Block@thinmail.com, and the system will find in database tables (not shown) the identity of the sender of the file. An alternative embodiment enables the sender to place the email address of the unwanted sender into the subject (as the parameter of the Block command). In a system which forwards email, it is common to set up a table of offending senders which is checked before email is forward. It is an objective of this invention to allow a user to block spam with a simple email message.

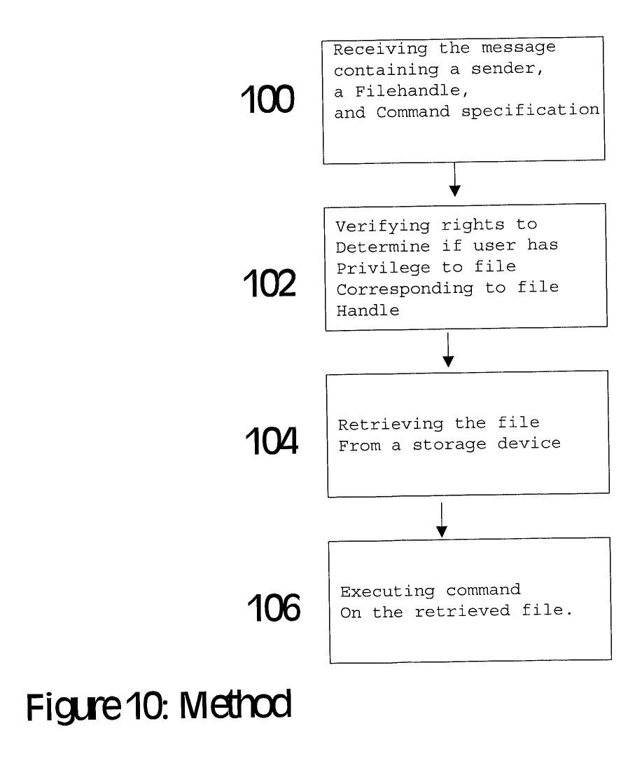

FIG. 10 shows the method of how the present invention operates. The first step is receiving from a sender an electronic mail item which contains a user identification, a file handle, and a command specification, 100. The next step is verifying rights to determine whether or not the identified user has privileges to access the file corresponding to the file handle, 102. The file is then retrieved from a storage device corresponding to the file handle, 104, and the command specification is executed on the file retrieved from the storage system when the identified user is verified to have the access rights to the file 106.

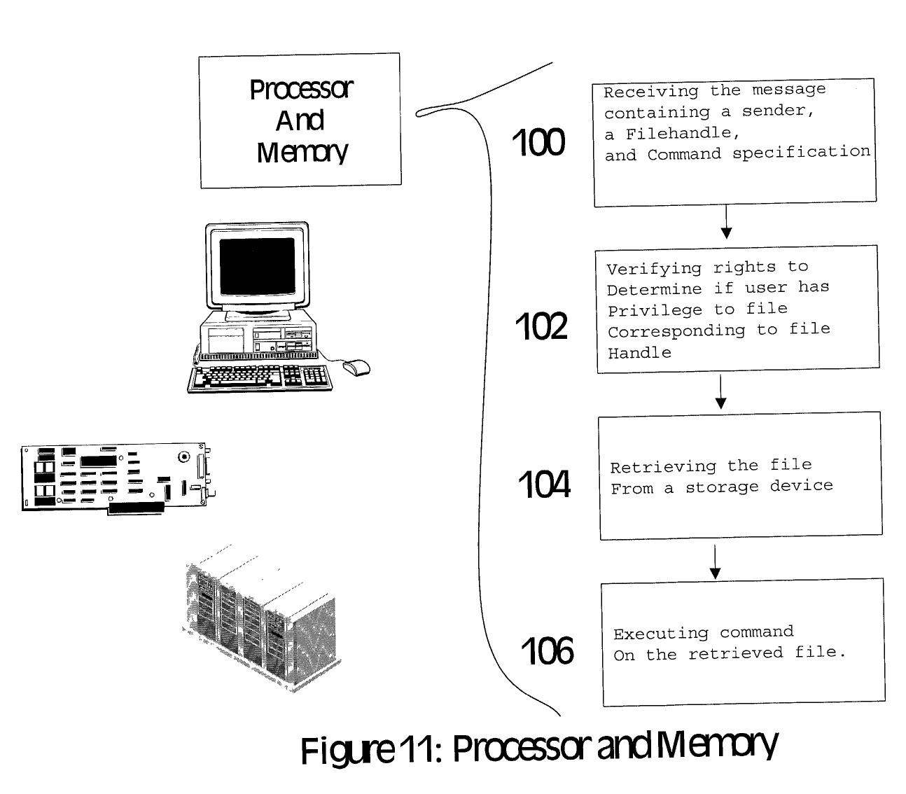

Additionally, the system and method can be embodied in a processor and memory, such as a personal computer, a cluster of network workstations, or a single board computer as shown in FIG. 11.

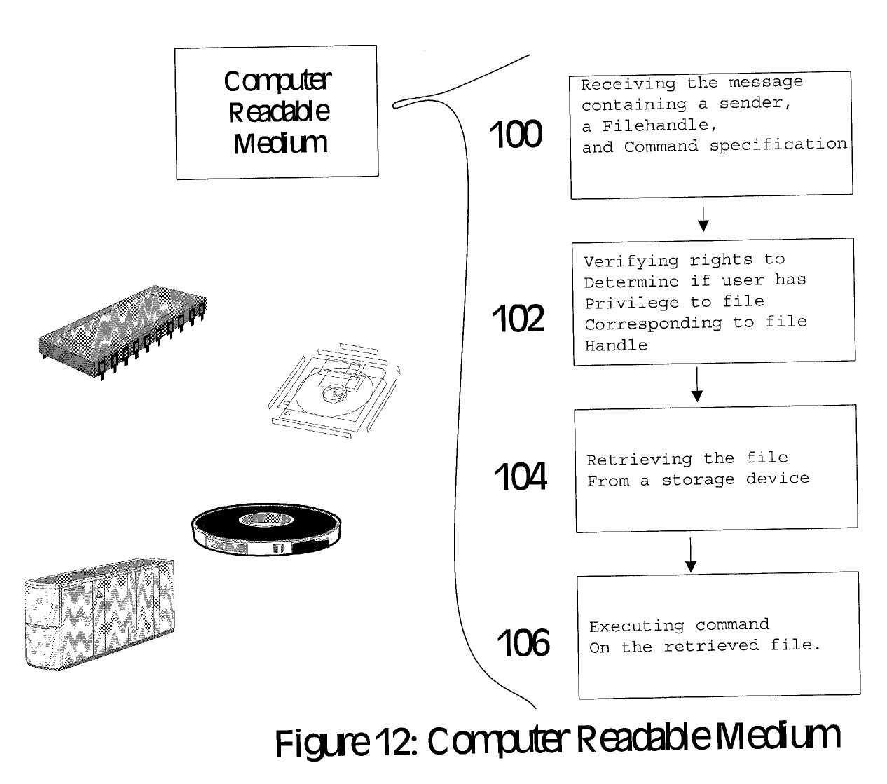

In another embodiment of the invention, the present system and method reside on a computer readable medium. See FIG. 12.

In operation of an embodiment of the invention, a web browser associated with the system of the present invention can prompt for an email address and a password, verify that the IP address of the requestor fits a pattern, or look for a “cookie” stored on the computer, which securely validates the user. Additionally, encryption of communications vial “ssl” may be enabled, or a virtual private network may be established between the server and that of a corporate customer. If a user accidently reveals a file handle to a third party, they will be stopped by the password, IP match, lack of VPN, or missing cookie.

From an email, the file handle can be combined with the “from” address to form a valid access key for a file. As added security, the messages can require encryption using PGP or another crypto system, or have to pass various origination tests, such as hidden headers and hashcodes.

Optionally, a user has several validated identities and can manipulate files from any validated email identity. Although the present system is discussed relating to a single email address, the present system can be managed and controlled from multiple email addresses, or from supervisory accounts for large scale customers.

Combining a validated email address with the security of the file handle, allows for the remote manipulation of files by simple email messages, including forwarding and deleting, faxing, conversion and listing. These simple messages may be connected to specific buttons or menu items on a portable device for seamless operation.

The commands are represented as individual symbols which look like email addresses (e.g. TEXT@THINMAIL.COM), and the options to the commands are general strings. The commands refer to file handles in the body of the message. One embodiment of this invention treats the TO: address in the email as the command, and treats the SUBJECT as the options. On devices which do not allow subjects, the first line of the body of the message can contain a escape code like “!!S this is the subject”.

This use of commands as email addresses allows a user to have a set of commands as names in an address book, and quickly “forward” a message received from Thinmail back to the server with a command for processing. The logic is as follows: 1) look up the FROM email address in the database to get USERID; 2) look for any valid FILE HANDLES in the message body; and 3) verify that the USERID has access to the file or replace with “**Reference to file deleted”. If the email command is received: 1) Interpret the subject as the command options, and 2) Perform the command or register a security violation.

Looking for the compliant file handles in the body of an email message is a pattern-recognition operation. The present system maintains a database which associates file handles with users, which enables the verification step.

### EXAMPLES

Consider that Joe@aol.com sent his resume as an attachment to jbpollack@palm.thinmail.net. A wireless palm device would receive an email message with the following content.

To: jbpollack@palm.net

From: joe@aol.com

Subject: I wanna Job

Hi jordan,

Give me a job. I attached my resume

[the message contained the following attachments processed by the system disclosed in the '886 application]

http://thinmail.com/v/2i83u3/resume.doc

As the palm computer does not run a common desktop application such as “Microsoft Word”, the resume cannot be viewed on the palm computer.

Some of the email commands by which the present invention would allow the palm computer user to manipulate the attachment follow:

### Example 1

### Converting Filetypes

The user can forward a message to text@thinmail.com and the server runs a program to extract text from the file and mail it back to the FROM email address. This is useful on a device which does not run a word-processing program, but can display text. The user can see what a document is about from a portable device. So, simply forwarding the message:

TO: text@thinmail.com

From: jbpollack@alm.net

Subject: [blank]

http://thinmail.com/v/2i83u3/resume.doc

would respond with

From: Daemon@thinmail.com

To: jbpollack@palm.net

Subject: Resume.doc converted to text

Joe Random

Desire: Seeks a high paying job

Credentials: none

Etc.

Other forms of conversion can be applied to files received and sent, for example JPEG@THINMAIL.COM can convert graphics formats, or PDF@THINMAIL.COM can convert many document formats to PDF. These commands may include optional arguments such as page numbers “pages 1-5”, or image sizes (“100×300”).

### Example 2

### Faxing, Fedexing, Phoning

A second example is that the user can forward the message or mail the file handle to fax@thinmail.com by placing a fax number as subject. The server would then send the attached file to a conventional “email to fax” gateway offered by numerous companies, and the body of the message would comprise the cover page. This is useful to get an immediate copy of a file received on a mobile device.

To: Fax@thinmail.com

From: jbpollack@palm.net

Subject: 7815551212

This fax is for Dr. Pollack!

http://thinmail.com/v/2i83u3/resume.doc

The FAX command may contain other variants, such as PHONE@thinmail.com, which would send a audio file, the audio track of a video-file, or convert text-to-speech, and send it to a telephone number. FEDEX@thinmail.com may take an address in the subject and print and mail attachments.

### Example 3

### Forwarding

An important aspect to the present invention is similar to the security for faxing. A user can now forward attachments to other people without having the attachments stored on their device. Simply sending the file handle to another person will not enable the other person to access the file without the correct user's password.

To enable users to forward attachments to each other while maintaining security, the present system scans the body of messages for file handles, makes sure that the sender has the rights for the given handle, and then substitutes a new file handle for the recipients or removes the file handle.

There may be different levels of users of the present invention. First-class users can have passwords, permanent cookies, and encrypted channels and the ability to pay for services like faxing and delivery. Other users will have less security and access to limited resources, while unknown users will still be able to use the present system and receive files which are deleted after being downloaded.

In summary, the ability to manage, manipulate, forward, convert, delete, can all be accomplished by simple email commands which use indirect references to stored files. These references, variously called file handles or URLs have a security model, combining the file handle with the FROM address of an electronic mail item, enabling convenient use of the system without a browser.

Although specific features of this invention are shown in some drawings and not others, this is for convenience only as each feature may be combined with any or all of the other features in accordance with the invention.

Other embodiments will occur to those skilled in the art and are within the following claims:

What is claimed is:

1. A system for management and manipulation of stored files through electronic mail items comprising:
a receiving portal for receiving from a sender an electronic mail item which contains a user identification, a file handle and a command specification;
a storage device containing a file corresponding to said file handle;
a rights verifier for determining whether or not the sender has privilege to access the stored file corresponding to said file handle; and
a command executor which executes said command specification on the file retrieved from said storage device when the sender is verified to have the access rights to the file.

2. The system for management and manipulation of stored files of claim 1 further including a file handle recognizer for locating conforming file handle patterns within the body of the electronic mail item.

3. The system for management and manipulation of stored files of claim 1 further including a user identification system which extracts information from the electronic mail item including the from address, destination address, the subject, the reply-to, and the body of the electronic mail item, to enable verification of the sender as a known user of the system.

4. The system for management and manipulation of stored files of claim 3 further including a command parser which recognizes and assembles a command out of the information extracted from the electronic mail item.

5. The system for management and manipulation of stored files of claim 1 wherein the command specification instructs said command executor to delete the file from said storage device.

6. The system for management and manipulation of stored files of claim 1 wherein the command specification instructs said command executor to retrieve the file as an email attachment.

7. The system for management and manipulation of stored files of claim 1 wherein the command specification instructs said command executor to forward the file to a third party as an email attachment.

8. The system for management and manipulation of stored files of claim 1 wherein the command specification instructs said command executor to forward to a third party a newly constructed file handle to the file stored on said storage device.

9. The system for management and manipulation of stored files of claim 1 wherein the command specification instructs said command executor to print the file on a fax machine at a specified telephone number.

10. The system for management and manipulation of stored files of claim 1 further including at least one of an optical character recognition device, automatic speech recognition device, language translation device, and a file format translation device associated with said command executor.

11. The system for management and manipulation of stored files of claim 1 wherein the command specification instructs said command executor to convert the file to plain text and email it back to the sender.

12. The system for management and manipulation of stored files of claim 1 wherein the command specification instructs said command executor to convert the file to an audio file and to forward the audio file to a telephone at a specified number.

13. The system for management and manipulation of stored files of claim 1 wherein the command specification instructs the command executor to automatically print the file and mail it to a third party.

14. The system for management and manipulation of stored files of claim 1 wherein the storage device further includes an automatic deletion timer associated with at least one of the stored files.

15. The system for management and manipulation of stored files of claim 1 wherein the command specification instructs the command executor to change the date of autodeletion of the file.

16. The system for management and manipulation of stored files of claim 1 wherein said file handle is a uniform resource locator.

17. The system for management and manipulation of stored files of claim 1 wherein the storage device is chosen from the group consisting of hard drives, optical drives, random access memories, tape drives, RAID arrays, and storage area networks.

18. A method for the electronic mail based management and manipulation of stored files comprising the steps of:
receiving from a sender an electronic mail item which contains an user identification, a file handle and a command specification;
determining whether or not the sender has privilege to access the stored file corresponding to the file handle;
retrieving the file from a storage device corresponding to the file handle; and
executing the command specification on the file retrieved from the storage device when the sender is determined to have access rights to the file.

19. A computer readable medium having a plurality of instructions stored thereon which, when executed by a processor, cause the processor to perform the steps of:
receiving from a sender an electronic mail item which contains an user identification, a file handle and a command specification;
determining whether or not the sender has privilege to access a file stored on a storage device corresponding to the file handle;
retrieving the stored file from the storage device; and
executing the command specification on the retrieved file when the sender is determined to have the access rights to said file.

20. The computer readable medium of claim 19 in which computer readable medium is a hard drive.

21. The computer readable medium of claim 19 in which the computer readable medium is an optical drive.

22. The computer readable medium of claim 19 in which the computer readable medium is a Random Access Memory.

23. The computer readable medium of claim 19 in which the computer readable medium is a Read Only Memory.

24. The computer readable medium of claim 19 in which the computer readable medium is a tape drive.

25. A processor and memory configured to perform the steps of:
receiving from a sender an electronic mail item which contains an user identification, a file handle, and a command specification;
determining whether or not the sender has privilege to access a file stored on a storage device corresponding to the file handle;
retrieving the stored file from the storage device; and
executing the command specification on the retrieved file when the sender is determined to have the access rights to the file.

26. The processor and memory of claim 25 in which the processor and memory are incorporated into a personal computer.

27. The processor and memory of claim 25 in which the processor and memory are incorporated into a programmable logic controller.

28. The processor and memory of claim 25 in which the processor and memory are incorporated into a single board computer.

29. The processor and memory of claim 25 in which the processor and memory are incorporated into an array of network servers.
